(19) United States
(12) Patent Application Publication
(10) Pub. No.: US 2023/0094616 A1
(43) Pub. Date: Mar. 30, 2023

(54) THIN FILM CAPACITOR, POWER SOURCE MODULE, AND ELECTRONIC DEVICE

(71) Applicant: TDK CORPORATION, Tokyo (JP)

(72) Inventors: Tadashi IINO, Tokyo (JP); Hiroyasu INOUE, Tokyo (JP); Hitoshi SAITA, Tokyo (JP)

(73) Assignee: TDK CORPORATION, Tokyo (JP)

(21) Appl. No.: 17/954,659

(22) Filed: Sep. 28, 2022

(30) Foreign Application Priority Data
Sep. 30, 2021 (JP) 2021-162086

(51) Int. Cl. H01G 4/33; H01G 4/20

(52) U.S. Cl. CPC H01G 4/33; H01G 4/206

(57) ABSTRACT

A thin film capacitor having a multilayer structure including a first electrode, a first dielectric layer, a second dielectric layer, and a second electrode in this order. The second dielectric layer and the second electrode are in contact. The first dielectric layer includes a perovskite type compound. The second dielectric layer includes a perovskite type compound or an oxide of M. When X1 and X2a represents an absolute value of an average energy for formation of an oxide of a cationic element included in a B site of the perovskite type compound included in the first dielectric layer and the second dielectric layer respectively, and X2b represents an absolute value of an average energy for formation of an oxide of M included in the second dielectric layer, then X2a<X1 and X2a≤1000 kJ/mol are satisfied or X2b<X1 and X2b≤1000 kJ/mol are satisfied.

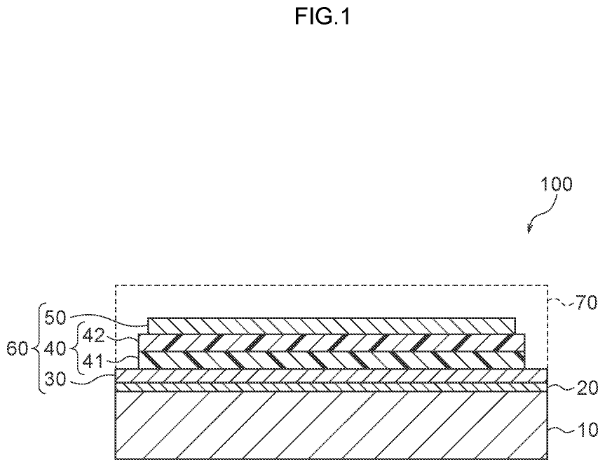

### TECHNICAL FIELD

The present invention relates to a thin film capacitor, a power source module, and an electronic device.

### BACKGROUND

Along with downsizing of a power source module which is used for an electronic device, a demand for downsizing an electronic component used for the electronic device has also increased.

The power source module is downsized by increasing a switching frequency of a power source. However, when the switching frequency is too high, a parasitic inductance caused from wires and a parasitic inductance of a mounted component itself tend to easily cause voltage fluctuation of a power source circuit. The voltage fluctuation may cause unexpected abnormal high voltage (such as, a surge voltage, ringing, and so on) and in some cases a switching element may be damaged. Even if the switching element is not damaged, a dielectric loss may occur and noise may be caused in some cases. Thus, it becomes necessary to constitute a power circuit barely influenced by abnormal high voltage, and to select a component which is barely influenced by abnormal high voltage. Therefore, it is demanded to suppress the voltage fluctuation.

A snubber circuit including a snubber capacitor may be formed around the switching element in order to suppress the voltage fluctuation. The abnormal high voltage can be suppressed by forming the snubber circuit. Further, studies have been carried out to reduce the parasitic inductance. Since a parasitic inductance of the thin film capacitor is small, research has been carried out to the use of the thin film capacitor to the power source module.

In some cases, the thin film capacitor may be used as a decoupling capacitor placed near LSI. In this case, the thin film capacitor is driven at a relatively low voltage, thus a high withstand voltage is not needed.

On the contrary to this, a thin film capacitor used for the power source circuit near the switching element is driven by a relatively high voltage, thus a high withstand voltage is needed. Generally, a permittivity and a withstand voltage show an inverse relationship. In order to obtain the thin film capacitor of high withstand voltage, it is necessary to use a dielectric layer with a low permittivity. However, when a thin film capacitor is made using such dielectric layer, in some cases, the adhesion between the dielectric layer and an electrode may decrease.

Patent Document 1 discloses an invention relating to a semiconductor device, and also discloses that a second insulator which suppresses excessive oxygen diffusion to a conductor from an insulator including an excessive oxygen area. However, it is unclear as to how much the second insulator contributes to an adhesion between the insulator and the conductor.

Patent Document 2 discloses an invention relating to an electronic component. In order to securely adhere an electrode layer and a dielectric layer, Patent Document 2 discloses to provide an adhesive metal layer between a main conductive layer and the dielectric layer. However, metals such as Cr, Ti, Ta, and the like included in the adhesive metal layer may oxidize and form oxides by contacting the main conductive layer and the dielectric layer, and there is a risk that the oxides may diffuse. In such case, properties of the dielectric layer may be compromised.

Patent Document 3 discloses an invention relating to a ceramic electronic component. Patent Document 3 discloses that dielectric layers having different orientations with each other form a thin film part of two layers, and thereby a leakage is reduced and a withstand voltage is improved. However, Patent Document 3 does not mention about the adhesiveness between the dielectric thin layer and an electrode.

[Patent Document 1] WO2020/188392

[Patent Document 2] JP Patent Application Laid Open No. 2007-173437

[Patent Document 3] JP Patent Application Laid Open No. H07-029768

### SUMMARY

The object of the present invention is to provide a thin film capacitor and the like achieving a high adhesiveness and a high withstand voltage.

The thin film capacitor according to the first aspect of the present invention is a thin film capacitor having a multilayer structure including a first electrode, a first dielectric layer, a second dielectric layer, and a second electrode in this order; wherein
the second dielectric layer and the second electrode are in contact;
the first dielectric layer and the second dielectric layer include a perovskite type compound; and
X2a<X1 and X2a≤1000 kJ/mol are satisfied, in which
X1 represents an absolute value of an average energy for formation of an oxide of a cationic element included in a B site of the perovskite type compound included in the first dielectric layer, and
X2a represents an absolute value of an average energy for formation of an oxide of a cationic element included in a B site of the perovskite type compound included in the second dielectric layer.

The thin film capacitor according to the second aspect of the present invention is a thin film capacitor having a multilayer structure including a first electrode, a first dielectric layer, a second dielectric layer, and a second electrode in this order; wherein
the second dielectric layer and the second electrode are in contact;
the first dielectric layer includes a perovskite type compound and the second dielectric layer includes an oxide of M; and
X2b<X1 and X2b≤1000 kJ/mol are satisfied, in which
X1 represents an absolute value of an average energy for formation of an oxide of a cationic element included in a B site of the perovskite type compound included in the first dielectric layer, and
X2b represents an absolute value of an average energy for formation of an oxide of M included in the second dielectric layer.

When ε₁ represents a relative permittivity of the first dielectric layer,
d₁ represents a thickness of the first dielectric layer,
d₂ represents a thickness of the second dielectric layer,
ε₂ represents a relative permittivity of the second dielectric layer, and
εrepresents a synthetic permittivity including ε₁ and ε₂;
ε≥0.8×ε₁×((d₁+d₂)/d₁) may be satisfied.

A withstand voltage of the first dielectric layer may be 0.30 kV/um or more.

A power source module according to the present invention includes the above-mentioned thin film capacitor.

An electronic component according to the present invention includes the above power source module.

### BRIEF DESCRIPTION OF THE SEVERAL VIEWS OF THE DRAWING(S)

FIGURE is a schematic diagram of a thin film capacitor according to the present invention.

### DETAILED DESCRIPTION

### First Embodiment

Hereinbelow, the first embodiment of the present invention is described in detail in the order as listed below.

1. Thin film capacitor
1.1 Overall configuration of thin film capacitor
1.2 Dielectric layer
1.3 Substrate
1.4 First electrode
1.5 Second electrode

2. Method of producing thin film capacitor

### 1. Thin Film Capacitor

First, the thin film capacitor according to the first embodiment of the present invention is described.

### 1.1 Overall Configuration of Thin Film Capacitor

As shown in FIGURE, a thin film capacitor 100 as an example of a dielectric element according to the present embodiment has a configuration such that a substrate 10, a first electrode 30, a dielectric layer 40, and a second electrode 50 are stacked in this order. When the first electrode 30 and the second electrode 50 are connected to an external circuit and voltage is applied, the dielectric layer 40 shows a predetermined capacitance, and a function as a capacitor can be exhibited. In below, each constitutional element is described in detail.

Note that, a shape of the thin film capacitor is not particularly limited, and usually it is a rectangular parallelepiped shape. Also, a size of the thin film capacitor is not particularly limited, and a thickness and a length may be appropriately changed depending on its use.

### 1.2 Dielectric Layer

In the present embodiment, the dielectric layer 40 includes the first dielectric layer 41 and the second dielectric layer 42. Further, as shown in FIGURE, the thin film capacitor 100 has a multilayer structure 60 in which the first electrode 30, the first dielectric layer 41, the second dielectric layer 42, and the second electrode 50 are stacked in this order. Further, the second dielectric layer 42 and the second electrode 50 are in contact with each other.

The first electrode 30 and the first dielectric layer 41 may be in contact with each other. The first dielectric layer 41 and the second dielectric layer 42 may be in contact with each other.

Another dielectric layer may be placed between the first electrode 30 and the first dielectric layer 41, and/or between the first electrode layer 41 and the second dielectric layer 42. In case said another dielectric layer is included, a composition and a thickness of said another dielectric layer are not particularly limited, as long as the high adhesiveness and the high withstand voltage are not compromised.

The first dielectric layer 41 and the second dielectric layer 42 include a perovskite type compound. The perovskite type compound according to the present embodiment is a perovskite type oxide which is represented by a formula ABO₃. In the above formula, A represents at least one A site constituting cationic element, and B represents at least one B site constituting cationic element.

Also, the first dielectric layer 41 and the second dielectric layer 42 may include a compound other than the perovskite type compound within an amount which does not compromise the high adhesiveness and the high withstand voltage. For example, the first dielectric layer 41 may include the compound other than the perovskite type compound in an amount of less than 50 mol %. For example, the second dielectric layer 42 may include the compound other than the perovskite type compound in an amount of less than 50 mol %.

Regarding the perovskite type compound included in the first dielectric layer and the perovskite type compound included in the second dielectric layer, a type of the element inserted in the A site of the perovskite type compound is not particularly limited. The type of element inserted in the A site of the perovskite type compound may be any generally known cationic element which is inserted in the A site of the perovskite type compound. For example, such cationic element inserted in the A site may be at least one selected from the group consisting of calcium (Ca), strontium (Sr), and barium (Ba).

Regarding the perovskite type compound included in the first dielectric layer and the perovskite type compound included in the second dielectric layer, a type of the element inserted in the B site of the perovskite type compound is not particularly limited. The type of the element included in the B site of the perovskite type compound may be any generally known cationic element which is inserted in the B site of the perovskite type compound. For example, such cationic element inserted in the B site may be at least one selected from the group consisting of titanium (Ti), zirconium (Zr), hafnium (Hf), tin (Sn), niobium (Nb), tantalum (Ta), magnesium (Mg), zinc (Zn), and nickel (Ni). The cationic element inserted in the B site may be at least one selected from the group consisting of Ti, Zr, Mg, and Ta. Note that, regarding the perovskite type compound included in the first dielectric layer, preferably a proportion of Ti is small with respect to the cationic element inserted in the B site. Specifically, regarding the perovskite type compound included in the first dielectric layer, the proportion of Ti to 100 parts by mol of the cationic elements inserted in the B site may preferably be 50 parts by mol or less. When the proportion of Ti to the cationic elements inserted in the B site is too large, the withstand voltage tends to decrease.

In the present embodiment, when an absolute value of an average energy for formation of an oxide of a cationic element included in the B site of the perovskite type compound included in the first dielectric layer 41 is represented by X1, and an absolute value an average energy for formation of an oxide of a cationic element included in the B site of the perovskite type compound included in the second dielectric layer 42 is represented by X2a, then X1 and X2a satisfy the relationship of

X2a<X1 and X2a≤1000 kJ/mol.

When the dielectric layer 40 includes the second dielectric layer 42 having a small X2a, the adhesiveness between the dielectric layer 40 and the second electrode 50 can be enhanced. In below, the reason for the enhanced adhesiveness is explained.

In order to improve the adhesiveness between an electrode and a dielectric layer, the electrode and the dielectric layer need to be strongly bonded at an interface between these. To strongly bond the electrode and the dielectric layer, a bonding condition of atoms included in the electrode and a bonding condition of atoms included in the dielectric layer need to have a similar bonding condition.

In general, atoms included in an electrode are bonded by an intermetallic bond. On the other hand, in general, atoms included in a dielectric layer are bonded by a covalent bond. Thus, the adhesiveness between the electrode and the dielectric layer tends to be weak.

Here, when the absolute value of an average energy for formation of an oxide of a cationic element included in the B site of the perovskite type compound included in the dielectric layer is small, the dielectric layer tends to be easily oxidized and also easily reduced. That is, the dielectric layer tends to be easily oxidized and also easily reduced at an atomic layer level in the interface where the dielectric layer and the electrode contact with each other. Therefore, when the absolute value of an average energy for formation of an oxide of a cationic element included in the B site of the perovskite type compound included in the dielectric layer is small, the bonding condition of the atoms at the interface in the dielectric layer side is similar to an intermetallic bond. Thus, when the absolute value of an average energy for formation of an oxide of a cationic element included in the B site of the perovskite type compound included in the dielectric layer is small, the adhesiveness between the electrode and the dielectric layer is enhanced. Also, to enhance the adhesiveness between the electrode and the dielectric layer using the above-mentioned mechanism, preferably the electrode may include at least one base metal.

An energy for formation of an oxide of each element is calculated by subtracting a standard Gibbs energy for formation of each element under a condition of a standard temperature of 298.15K and a standard pressure of 1.01325×10⁵ Pa from a standard Gibbs energy for formation of an oxide of each element under a condition of a standard temperature of 298.15K and a standard pressure of 1.01325×10⁵ Pa. The standard Gibbs energy for formation of each element under a standard temperature and a standard pressure is widely known. Also, the standard Gibbs energy for formation of an oxide of each element under a standard temperature and a standard pressure is widely known. An average energy for formation of an oxide of each element is calculated by taking a weight average according to an amount proportion (mol fraction) of each element.

A composition of the perovskite type compound included in the first dielectric layer 41 is not particularly limited.

The composition of the perovskite type compound can be expressed by a formula xA₁O_{-y}B_{1′}O_{-z}B_{1″2}O₅ (atomic ratio). When the A site constituting cation element is represented by A₁, A₁ is at least one element selected from the group consisting of Ca, Sr, and Ba. In the above formula, B_{1′} and B_{1″} are separate B site constituting cationic elements. For example, B_{1′} may be at least one selected from the group consisting of Mg, Zn, and Ni. For example, B_{1′} may be at least one selected from the group consisting of Ti, Nb, Zr, and Ta.

In the perovskite type compound included in the first dielectric layer 41, for example, x, y, and z of the above formula may satisfy the following.
x+y+z=1.000
0.375≤x≤0.563
0.250≤y≤0.500
x/3≤z≤x/3+ 1/9

The composition of the perovskite type compound included in the second dielectric layer is not particularly limited.

When ε₁ represents a relative permittivity of the first dielectric layer 41, d₁ represents a thickness of the first dielectric layer 41, ε₂ represents a relative permittivity of the second dielectric layer 42, and ε represents a synthetic permittivity including ε₁ and ε₂, then these satisfy the relationship of ε≥0.8×ε₁×((d₁+d₂)/d₁).

Comparison is made between the case that the dielectric layer 40 only includes the dielectric layer 41 and not the second dielectric layer 42 and the case that the dielectric layer 40 includes both of the first dielectric layer 41 and the second dielectric layer 42. If the thicknesses of the dielectric layers 40 from the above cases are the same, the case that the dielectric layer 40 includes both of the first dielectric layer 41 and the second dielectric layer 42 has a lower withstand voltage compared to the case that the dielectric layer 40 only includes the first dielectric layer 41 and not the second dielectric layer 42. If the dielectric layer 40 is made thicker then the withstand voltage of the dielectric layer 40 increases, but a capacity of the capacitor 100 decreases. When ε≥0.8×ε₁×((d₁+d₂)/d₁) is satisfied, a rate of decrease in capacity of the thin film capacitor 100 is 20% or less in case the dielectric layer 40 is made thicker without changing the withstand voltage.

In below, a method of calculating ε is described. When an electrode area of the thin film capacitor 100 is represented by S, and when V₁=Sd₁, V₂=Sd₂, α:β=V₁/(V₁+V₂):V₂/(V₁+V₂), and α+β=1, then the below equation is satisfied. According to the below equation, log ε can be calculated, and ε can be calculated from log ε. Note that, in the below equation, the base of logarithm is 10.

log ε=α log ε₁+β log ε₂=(d₁ log ε₁+d₂ log ε₂)/(d₁+d₂)

The withstand voltage of the first dielectric layer 41 is not particularly limited. The withstand voltage of the first dielectric layer 41 may be 0.30 kV/um or more, and it may be 0.50 kV/um or more.

The withstand voltage of the dielectric layer 40 is not particularly limited. The withstand voltage of the dielectric layer 40 may be 0.30 kV/um or more, and it may be 0.50 kV/um or more.

The thickness of the dielectric layer 40 is not particularly limited. Preferably, the thickness of the dielectric layer 40 may be within a range of 1.0 um to 6.0 um. Also, d₁ is not particularly limited, and it may preferably be within a range of 0.5 um to 5.5 um. Further, d₂ is not particularly limited, and it may preferably be within a range of 0.1 um to 0.5 um.

The thickness of the dielectric layer 40 can be measured by processing the thin film capacitor including the dielectric layer 40 using a FIB (Focused Ion Beam) processing device, then observing the obtained cross section using SEM (Scanning Electron Microscope). For measuring d₁ and d₂, the same method may be used. Note that, in case the first dielectric layer 41 and the second dielectric layer 42 can not be distinguished using SEM, then these may be distinguished by a crystal orientation observation using a transmission electron microscope (TEM), or by a crystal orientation observation using an electron back scattered diffraction (EBSD).

### 1.3 Substrate

A type of the substrate 10 is not particularly limited, as long as it is constituted by a material which is chemically and thermally stable, and does not hardly gives stress on the substrate 10 and capable of maintaining a smooth surface of the substrate 10. For example, a monocrystal substrate constituted for example by Si monocrystal, sapphire monocrystal, SrTiO₃ monocrystal, MgO monocrystal, and so on; a ceramic polycrystal substrate constituted by, for example, alumina (Al₂O₃), magnesia (MgO), forsterite (2MgO.SiO₂), steatite (MgO.SiO₂), mullite (3Al₂O₃.2SiO₂), beryllia (BeO), zirconia (ZrO₂), aluminum nitride (AlN), silicon nitride (Si₃N₄), silicon carbide (SiC), and so on; a glass ceramic substrate (LTCC substrate) constituted by, for example, alumina (crystal phase) and silicon oxide (glass phase) obtained by firing at 1000° C. or lower; a glass substrate such as fused glass and the like; a metal substrate constituted for example by Fe—Ni alloy and so on may be mentioned. Also, the substrate 10 may be a metal foil made of nickel (Ni) or copper (Cu).

The metal foil may be provided as the substrate 10 and the first electrode 30. When the metal foil is provided as the substrate 10 and the first electrode 30, then the below described insulation layer 20 is not formed. When the metal foil is provided as the substrate 10 and the first electrode 30, the thin film capacitor 100 can be easily mounted on the electronic circuit board. Therefore, by using the metal foil as the substrate 10, the thin film capacitor 100 can be even thinner, and contributes to a further improved flexibility and to a further reduced substrate cost. When the metal foil is provided as the substrate 10 and the first electrode 30, the thickness of the metal foil is not particularly limited. For example, it may be 1 um or more and 1000 um or less.

In below, unless mentioned otherwise, the case that the metal foil is not provided as the substrate 10 and the first electrode 30 is described.

The thickness of the substrate 10 is not particularly limited. It may be within a range of 10 um to 5000 um.

The resistivity of the substrate 10 may be different depending on the used material. When the substrate 10 is constituted by a material of a low resistivity, current may leak to the substrate 10 from the multilayer structure 60 while the thin film capacitor 100 is operating. As a result, electric properties of the thin film capacitor 100 may be affected. Therefore, when the electric resistivity of the substrate 10 is low, preferably an insulation treatment may be performed to the surface of the substrate 10 at the side of the multilayer structure 60, so that the current formed while the thin film capacitor 100 is operating does not flow to the substrate 10.

For example, when the substrate 10 is a Si monocrystal substrate, the insulation layer 20 may be preferably formed on the surface of the substrate 10. A material constituting the insulation material is not particularly limited as long as it is the material which ensures secure insulation between the substrate 10 and the multilayer structure 60. For example, it may be SiO₂, Al₂O₃, Si₃Nₓ, and the like. Also, the thickness of the insulation layer 20 is not particularly limited, and it may be within a range of 0.01 um or more and 1 um or less.

### 1.4 First Electrode

As shown in FIGURE, the first electrode 30 is formed on the substrate 10 via the insulation layer 20. The first electrode 30 may be a thin film form. That is, the first electrode 30 may be an electrode film. The dielectric layer 40 is held between the first electrode 30 and the second electrode 50, and the first electrode 30 is an electrode which enables the thin film capacitor 100 to function as a capacitor. The first electrode 30 may be constituted by a material having conductivity. As the material having conductivity, simple metals such as Au, Pt, Ag, Ir, Ru, Co, Ni, Fe, Cu, Al, and the like; alloys of these metals; semiconductors such as Si, GaAs, GaP, InP, SiC, and the like; conductive metal oxides such as ITO, ZnO, SnO₂, and the like may be mentioned. Preferably, a material including a base metal as the material having conductivity may be used. As the material including the base metal, a simple Ni, a simple Cu, or an alloy of Ni—Cu may be used particularly preferably.

A thickness of the first electrode 30 is not particularly limited. The thickness of the first electrode 30 may be a thickness which allow the electrode 30 to function as an electrode. The thickness of the first electrode 30 may be within a range of 0.01 um or more and 1 um or less.

In order to enhance the adhesiveness between the substrate 10 and the first electrode 30, an adhesive layer may be formed on the substrate 10 before forming the first electrode 30. A material for forming the adhesive layer is not particularly limited as long as the adhesiveness between the substrate 10 and the first electrode 30 is enhanced. For example, titanium oxides and chromium oxides may be mentioned. Note that, when the insulation layer 20 is formed, the above-mentioned substrate 10 shall be replaced with the insulation layer 20.

### 1.5 Second Electrode

As shown in FIGURE, the second electrode 50 is formed on the surface of the dielectric layer 40. The second electrode 50 may be a thin film form. That is, the second electrode 50 may be an electrode film. The dielectric layer 40 is held between the second electrode 50 and the first electrode 30, and the second electrode 50 is an electrode which enables the thin film capacitor to function as a capacitor. Therefore, the second electrode 50 and the first electrode 30 have different polarities.

As similar to the first electrode 30, the second electrode 50 may be constituted by a material having conductivity. As the material having conductivity, simple metals such as Au, Pt, Ag, Ir, Ru, Co, Ni, Fe, Cu, Al, and the like; alloys of these metals; semiconductors such as Si, GaAs, GaP, InP, SiC, and the like; conductive metal oxides such as ITO, ZnO, SnO₂, and the like may be mentioned. Preferably, a material including a base metal as the material having conductivity may be used. As the material including the base metal, a simple Ni, a simple Cu, or an alloy of Ni—Cu may be used particularly preferably. This is because the adhesiveness between the second dielectric layer 42 and the second electrode 50 can be enhanced when the material including the base metal is used as the second electrode 50.

The thickness of the second electrode 50 is not particularly limited. The thickness of the second electrode 50 may be a thickness so that the second electrode can function as an electrode. The thickness of the second electrode 50 may be within a range of 0.01 um or more and 100 um or less.

### 2. Method of Thin Film Capacitor

Next, an example of a method of producing the thin film capacitor 100 shown in FIGURE is described in below.

First, the substrate 10 is prepared. When a Si monocrystal substrate is prepared as the substrate 10, if needed, the insulation layer 20 is formed to a main plane at one side of the Si single monocrystal substrate. A method of forming the insulation layer 20 is not particularly limited. For example, a known layer forming method may be used such as a thermal oxidation method, CVD (Chemical Vapor Deposition) method, and the like.

Next, if needed, the adhesive layer may be formed on the insulation layer 20 (when the insulation layer 20 is not formed, the adhesive layer is formed on the substrate 10) using a known layer forming method.

Next, using a known layer forming method, the first electrode 30 is formed on the substrate 10, on the insulation layer 20, and on the adhesive layer.

Note that, when the metal foil is used as the substrate 10 and the first electrode 30, a metal foil which functions both as the substrate 10 and the first electrode 30 is prepared.

Next, the dielectric layer 40 is formed on the first electrode 30. Specifically, after forming the first dielectric layer 41, the second dielectric layer 42 is formed on the first dielectric layer 41. A method of forming the dielectric layer 41 and the second dielectric layer 42 is not particularly limited. Using a known layer forming method, the material constituting each dielectric layer is deposited as a deposited film in a form of thin film, thereby each of the dielectric layers is formed.

As the known layer forming method, a vapor deposition method, a spattering method, a PLD (pulse laser deposition) method, a MO-CVD (metalorganic chemical vapor deposition) method, a MOD (metalorganic decomposition) method, a sol-gel method, a CSD (chemical solution deposition) method, and the like may be mentioned.

In raw materials used for forming each dielectric layer (vapor deposition materials, various target materials, metalorganic materials, and so on), trace amounts of impurities, subcomponents, and the like may be included as long as the high adhesiveness and the high withstand voltage are not compromised.

Next, the second electrode 50 is formed on the dielectric layer 40 using a known layer forming method.

An annealing treatment may be carried out before or after forming the second electrode 50. Annealing conditions are not particularly limited. For example, the annealing treatment may be carried out at an annealing temperature within a range of 300° C. to 1000° C. for an annealing time of 30 minutes to 120 minutes under the atmosphere which does not oxidize an electrode. In case there is a component remaining in the dielectric layer which should have been formed into a perovskite type compound while the dielectric layer is forming, such component is formed into a perovskite type compound by carrying out the annealing treatment. The atmosphere which does not oxidize an electrode means that the atmosphere has an oxygen content of 1% or less. Specifically, the atmosphere made of a mixed gas of hydrogen, nitrogen, and vapor; and the atmosphere made by using a separation of oxygen from carbon monoxide and/or carbon dioxide may be mentioned. The atmosphere which does not oxidize an electrode may be a vacuum atmosphere of 100 Pa or less.

Also, if needed, a passivation layer (protective layer) may be formed. As a material for the passivation layer, an inorganic material such as SiO₂, Al₂O₃, and the like; an organic material such as an epoxy resin, a polyimide resin, and the like can be used.

By going through the above-mentioned steps, the thin film capacitor 100 of which the multilayer structure 60 (the first electrode 30, the dielectric layer 40, and the second electrode 50) formed on the substrate 10 is obtained. Note that, the protective layer 70 for protecting the dielectric layer 40 may be formed using a known layer forming method so that at least an exposed area of the dielectric layer 40 is covered by the protective layer 70. A material of the protective layer 70 is not particularly limited, and a known material may be used as the protective layer for protecting the dielectric layer.

### Second Embodiment

Hereinbelow, the second embodiment of the present invention is described. The parts of the second embodiment which are not mentioned in here is the same as the first embodiment.

In the present embodiment, the first dielectric layer 41 includes the perovskite type compound. The perovskite type compound according to the present embodiment is a perovskite type compound which can be expressed by ABO₃. In the above formula, A represents at least one A site constituting cationic element, and B represents at least one B site constituting cationic element.

The second dielectric layer 42 includes an oxide of M. A type of M is not particularly limited. For example, Si, Ti, Zn, Al, Fe, Hf, Ta, Nb, and Zr may be mentioned. The oxide of M may be an oxide of single element. The oxide of single element means that it is a compound of oxygen and one element selected from elements other than oxygen.

Also, in the first dielectric layer 41, a compound other than perovskite type compound may be included within a range which does not compromise the high adhesiveness and the high withstand voltage. In the second dielectric layer 42, a compound other than the oxide of M may be included within a range which does not compromise the high adhesiveness and the high withstand voltage. For example, in the first dielectric layer 41, the compound other than perovskite type compound may be included in an amount of less than 50 mol %. For example, in the second dielectric layer 42, the compound other than the oxide of M may be included in an amount of less than 50 mol %.

In the present embodiment, X2b<X1 and X2b≤1000 kJ/mol are satisfied in which X1 represents an absolute value of the average energy for formation of an oxide of a cationic element included in the B site of the perovskite type compound included in the first dielectric layer 41, and X2b represents an absolute value of an average value of formation of an oxide of M included in the second dielectric layer 42.

By including the second dielectric layer 42 of small X2b in the dielectric layer 40, the adhesiveness between the dielectric layer 40 and the second electrode 50 can be enhanced. The reason for the enhanced adhesiveness is described in below.

In order to enhance the adhesiveness between an electrode and a dielectric layer, these needs to be strongly bonded at the interface between the electrode and the dielectric layer. To strongly bond the electrode and the dielectric layer, a bonding condition of atoms included in the electrode and a bonding condition of atoms included in the dielectric layer need to be a similar bonding condition.

In general, atoms included in an electrode are bonded by an intermetallic bond. On the other hand, in general, atoms included in a dielectric layer are bonded by a covalent bond. Thus, the adhesiveness between the electrode and the dielectric layer tends to be weak.

Here, when the absolute value of an average energy for formation of an oxide of M included in a dielectric layer is small, the dielectric layer tends to be easily oxidized and reduced. That is, the dielectric layer tends to be easily oxidized and also easily reduced in an atomic layer level at the interface where the dielectric layer and the electrode contact with each other. Therefore, when the absolute value of an average energy for formation of an oxide of M included in the dielectric layer is small, the bonding condition of the atoms in the interface at the dielectric layer side is close to an intermetallic bond. Thus, when the absolute value of an average energy for formation of an oxide of M included in the dielectric layer is small, the adhesiveness between the electrode and the dielectric layer is enhanced.

Hereinabove, the first embodiment and the second embodiment have been described, however the present invention is not limited to these embodiments, and the embodiments may be variously modified within the scope of the present invention.

The use of the thin film capacitor of each embodiment is not particularly limited. For example, a snubber capacitor used for a DC converter, an AC-AC converter, a DC-AC inverter, and the like may be mentioned. Also, a power source module in which the thin film capacitor is mounted may be mentioned. Further, an electronic device including the power source module such as a digital TV, a server, an automobile mounting device, and the like may be mentioned.

### EXAMPLES

In below, the present invention is described in further detail using examples and comparative examples. Note that, the present invention is not limited to the below examples.

### Experiment Example 1

First, a target for forming a first dielectric layer and a second dielectric layer was produced as described in below.

As raw material powders of the target, powders of strontium carbonate (SrCO₃), calcium carbonate (CaCO₃), barium carbonate (BaCO₃), titanium oxide (TiO₂), zirconium oxide (ZrO₂), magnesium oxide (MgO), and tantalum oxide (Ta₂O₅) were prepared. These powders were weighed so that the composition of each dielectric layer shown in Table 1 and Table 2 were attained.

The weighed raw material powders of the target was wet mixed for 20 hours in a ball mill using water as a solvent. The obtained mixed powder slurry was dried at 100° C., and thereby obtained the mixed powder. The obtained mixed powder was press molded using a pressing machine, and obtained a molded body. A molding condition was a pressure of 100 Pa, a temperature of 25° C., and a pressing time of 3 minutes.

Then, the obtained molded body was fired and a sintered body was obtained. As a firing condition, a holding temperature was within a range of 1300° C. to 1400° C., a holding time was within a range of 2 hours to 5 hours, and the atmosphere was in the air.

The obtained sintered body was processed into a size having a diameter of 200 mm and a thickness of 6 mm, using a surface grinding machine and a cylindrical grinding machine, thereby obtained a target for forming each dielectric layer.

Next, a Ni foil and a Cu foil were prepared as metal foils which each function both as a substrate and a first electrode. The metal foil had a size of 100 mm×100 mm×0.05 mm.

Then, using the target for forming a first dielectric layer, the first dielectric layer was formed on the metal foil so that the first dielectric layer had a thickness d₁ shown in Table 1 and Table 2.

Next, using the target for forming a second dielectric layer, the second dielectric layer was formed on the first dielectric layer by a spattering method so that the second dielectric layer had a thickness d₂ shown in Table 1 and Table 2.

As a condition for forming each dielectric layer, a substrate temperature was 400° C., and a pressure was 0.1 Pa.

Next, before forming the second electrode, a reduction firing was carried out at 600° C. Then, a thin film of a metal element shown in Table 1 and Table 2 was formed as the second electrode on the second dielectric layer using a spattering method, thereby the thin film capacitor shown in Table 1 and Table 2 was obtained.

For each sample, the composition of the first dielectric layer and the composition of the second dielectric layer were analyzed using XRF (X-ray fluorescent element analysis), and verified that these compositions matched with the compositions shown in Table 1 and Table 2. A thin film capacitor sample was processed using FIB, and the thickness of the first dielectric layer and the thickness of the second dielectric layer were measured from the obtained cross section using SEM (scanning electron microscope).

For all of the obtained thin film capacitors, a relative permittivity, a withstand voltage, and an adhesive strength were measured using a method shown in below.

The relative permittivity was calculated from a capacitance measured under a condition of at room temperature of 25° C. and a measuring frequency of 1 kHz (1 Vrms) using an impedance analyzer (E4980A) to each thin film capacitor, and from an electrode size of the thin film capacitor and a distance between the electrodes.

The relative permittivity ε₁ of the first dielectric layer was a relative permittivity of a thin film capacitor sample produced under the same condition except that the second dielectric layer was not formed. Results are shown in Table 1 and Table 2.

The relative permittivity ε₂ of the second dielectric layer was set to a relative permittivity of a thin film capacitor sample produced under the same condition except that the first dielectric layer was not formed. Results are shown in Table 1 and Table 2.

A synthetic permittivity ε was calculated using a method described in above. Results are shown in Table 1 and Table 2. Also, the relative permittivity ε of each thin film capacitor was measured and verified that this matched with the synthetic permittivity ε.

A withstand voltage was obtained by measuring the voltage at the point when 50 mA or higher current flew when DC current was applied at a voltage rising rate of 1 V/s. Also, to obtain a withstand voltage, a withstand voltage of a thin film capacitor sample and a withstand voltage of a thin film capacitor sample produced under the same condition except that the second dielectric layer was not formed (a withstand voltage of the first dielectric layer) were measured. Results are shown in Table 1 and Table 2. Regarding the withstand voltage of the first dielectric layer of 0.10 kV/um or more was considered good, 0.30 kV/um or more was considered better, and 0.50 kV/um or more was considered even better. Regarding the withstand voltage of the thin film capacitor sample, 0.10 kV/um or more was considered good, 0.30 kV/um or more was considered better, and 0.50 kV/um or more was considered even better.

The adhesive strength was measured by adhering and pulling an aluminum pull stud. The method of measuring the adhesive strength is described in below.

As the aluminum pull stud, an epoxy adhesive coated aluminum pull stud having a tip diameter of 2.7 mmΦ (made by Quad Group) was used. Next, the aluminum pull stud was adhered to the second electrode of the evaluation sample. Specifically, a surface of the aluminum pull stud where the epoxy adhesive was adhered was pressed against the second electrode, and heated for 1 hour at 150° C. Then, a cut was made to the second electrode which surrounds the area where the pull stud was adhered.

Separately from the above, a clamp was installed to a digital force gage RZ-50 (made by Aikoh Engineering Co., Ltd.).

Then, the evaluation sample was fixed and the pull stud was held using the clamp. Next, the pull stud was pulled up in a vertical direction at a speed of 15 mm/min. A maximum value of a tensile stress while pulling the pull stud was measured, and thereby the adhesive strength was obtained.

The adhesive strength of 10.0 N/mm² or more was considered good. When the adhesive strength was 10.0 N/mm² or more and the adhesive strength without having the second dielectric layer was 1.0 N/mm² or more, then it was considered even better.

TABLE 1

| | Example/ | | 1st | | | | 2nd | | |
|---|---|---|---|---|---|---|---|---|---|
| Sample | Comparative | 1st | dielectric | | d₁ | X1 | dielectric | | d₂ |
| No. | example | electrode | layer | ε₁ | (um) | (kJ/mol) | layer | ε₂ | (um) |
| 1 | Example | Ni | CaZrO₃ | 30 | 2 | 1043 | BaTiO₃ | 800 | 0.01 |
| 2 | Example | Ni | CaZrO₃ | 30 | 2 | 1043 | BaTiO₃ | 800 | 0.2 |
| 3 | Example | Ni | CaTi_{0.2}Zr_{0.8}O₃ | 40 | 2 | 1012 | BaTiO₃ | 800 | 0.2 |
| 4 | Example | Ni | Ca_{0.9}Sr_{0.1}Ti_{0.2}Zr_{0.8}O₃ | 45 | 2 | 1012 | BaTiO₃ | 800 | 0.2 |
| 5 | Example | Ni | Ba(Mg_{1.73/3}Ta_{2.08/3})O₃ | 30 | 2 | 1914 | BaTiO₃ | 800 | 0.2 |
| 6 | Example | Ni | CaZrO₃ | 30 | 2 | 1043 | SrTiO₃ | 300 | 0.2 |
| 7 | Example | Ni | CaTi_{0.2}Zr_{0.8}O₃ | 40 | 2 | 1012 | SrTiO₃ | 300 | 0.2 |
| 8 | Example | Ni | Ca_{0.9}Sr_{0.1}Ti_{0.2}Zr_{0.8}O3 | 45 | 2 | 1012 | SrTiO₃ | 300 | 0.2 |
| 9 | Example | Ni | Ba(Mg_{1.73/3}Ta_{2.08/3})O₃ | 30 | 2 | 1914 | SrTiO₃ | 300 | 0.2 |
| 10 | Example | Ni | CaZrO₃ | 30 | 2 | 1043 | CaTiO₃ | 150 | 0.2 |
| 11 | Example | Ni | CaTi_{0.2}Zr_{0.8}O₃ | 40 | 2 | 1012 | CaTiO₃ | 150 | 0.2 |
| 12 | Example | Ni | Ca_{0.9}Sr_{0.1}Ti_{0.2}Zr_{0.8}O₃ | 45 | 2 | 1012 | CaTiO₃ | 150 | 0.2 |
| 13 | Example | Ni | Ba(Mg_{1/3}Ta_{2/3})O₃ | 30 | 2 | 1615 | CaTiO₃ | 150 | 0.2 |
| 14 | Example | Ni | BaTi_{0.9}Zr_{0.1}O₃ | 800 | 2 | 905 | SrTiO₃ | 300 | 0.1 |
| 15 | Example | Ni | BaTi_{0.8}Zr_{0.2}O₃ | 400 | 2 | 920 | SrTiO₃ | 300 | 0.1 |
| 16 | Example | Ni | BaTi_{0.9}Zr_{0.1}O₃ | 800 | 2 | 905 | SrTiO₃ | 300 | 0.2 |
| 17 | Example | Ni | BaTi_{0.8}Zr_{0.2}O₃ | 400 | 2 | 920 | SrTiO₃ | 300 | 0.2 |
| 18 | Example | Ni | BaTi_{0.9}Zr_{0.1}O₃ | 800 | 2 | 905 | SrTiO₃ | 300 | 0.01 |
| 19 | Example | Ni | BaTi_{0.8}Zr_{0.2}O₃ | 400 | 2 | 920 | SrTiO₃ | 300 | 0.01 |
| 20 | Comparative | Ni | CaZrO₃ | 30 | 2 | 1043 | Ba(Mg_{1/3}Ta_{2/3})O₃ | 30 | 0.2 |
| | example | | | | | | | | |
| 21 | Comparative | Ni | CaTi_{0.2}Zr_{0.8}O₃ | 40 | 2 | 1012 | Ba(Mg_{1/3}Ta_{2/3})O₃ | 30 | 0.2 |
| | example | | | | | | | | |
| 22 | Comparative | Ni | Ca_{0.9}Sr_{0.1}Ti_{0.2}Zr_{0.8}O₃ | 45 | 2 | 1012 | Ba(Mg_{1/3}Ta_{2/3})O₃ | 30 | 0.2 |
| | example | | | | | | | | |
| 23 | Comparative | Ni | Ba(Mg_{1/3}Ta_{2/3})O₃ | 30 | 2 | 1615 | CaZrO₃ | 30 | 0.2 |
| | example | | | | | | | | |
| 24 | Comparative | Ni | CaZrO₃ | 30 | 2 | 1043 | Ba(Mg_{1/3}Ta_{2/3})O₃ | 30 | 0.2 |
| | example | | | | | | | | |
| 25 | Comparative | Ni | CaTi_{0.2}Zr_{0.8}O₃ | 40 | 2 | 1012 | Ba(Mg_{1/3}Ta_{2/3})O₃ | 30 | 0.2 |
| | example | | | | | | | | |
| 26 | Comparative | Ni | Ca_{0.9}Sr_{0.1}Ti_{0.2}Zr_{0.8}O₃ | 45 | 2 | 1012 | Ba(Mg_{1/3}Ta_{2/3})O₃ | 30 | 0.2 |
| | example | | | | | | | | |
| 27 | Comparative | Ni | Ba(Mg_{1/3}Ta_{2/3})O₃ | 30 | 2 | 1615 | CaZrO₃ | 30 | 0.2 |
| | example | | | | | | | | |

| | | | | | Adhesive | | Withstand | |
|---|---|---|---|---|---|---|---|---|
| | | | | | strength | | voltage | |
| | | | | | (no 2nd | | (no 2nd | |
| | | | | | dielectric | Adhesive | dielectric | Withstand |
| Sample | X2a | 2nd | | 0.8 × ε₁ × | layer) | strength | layer) | voltage |
| No. | (kJ/mol) | electrode | ε | ((d₁ + d₂)/d₁) | (N/mm²) | (N/mm²) | (kV/um) | (kV/um) |
| 1 | 890 | Cu | 30 | 24 | 5.8 | 11.4 | 0.57 | 0.59 |
| 2 | 890 | Cu | 40 | 26 | 5.8 | 11.4 | 0.57 | 0.61 |
| 3 | 890 | Cu | 53 | 35 | 5.9 | 10.3 | 0.49 | 0.51 |
| 4 | 890 | Cu | 58 | 40 | 5.7 | 10.4 | 0.47 | 0.50 |
| 5 | 890 | Cu | 40 | 26 | 5.7 | 11.9 | 0.57 | 0.59 |
| 6 | 890 | Cu | 37 | 26 | 5.8 | 10.7 | 0.57 | 0.55 |
| 7 | 890 | Cu | 48 | 35 | 5.9 | 11.3 | 0.49 | 0.49 |
| 8 | 890 | Cu | 53 | 40 | 5.7 | 11.2 | 0.47 | 0.46 |
| 9 | 890 | Cu | 37 | 26 | 5.7 | 12.0 | 0.57 | 0.56 |
| 10 | 890 | Cu | 35 | 26 | 5.8 | 12.1 | 0.57 | 0.57 |
| 11 | 890 | Cu | 45 | 35 | 5.9 | 11.9 | 0.49 | 0.50 |
| 12 | 890 | Cu | 50 | 40 | 5.7 | 12.3 | 0.47 | 0.47 |
| 13 | 890 | Cu | 35 | 26 | 5.7 | 12.3 | 0.56 | 0.57 |
| 14 | 890 | Cu | 763 | 672 | 12.3 | 12.2 | 0.20 | 0.19 |
| 15 | 890 | Cu | 395 | 336 | 12.1 | 12.2 | 0.25 | 0.19 |
| 16 | 890 | Cu | 732 | 704 | 12.3 | 12.2 | 0.20 | 0.19 |
| 17 | 890 | Cu | 390 | 352 | 12.1 | 12.2 | 0.25 | 0.25 |
| 18 | 890 | Cu | 796 | 643 | 12.3 | 12.2 | 0.20 | 0.19 |
| 19 | 890 | Cu | 399 | 322 | 12.1 | 12.2 | 0.25 | 0.24 |
| 20 | 1615 | Cu | 30 | 26 | 5.8 | 6.4 | 0.57 | 0.58 |
| 21 | 1615 | Cu | 39 | 35 | 5.9 | 5.7 | 0.49 | 0.50 |
| 22 | 1615 | CU | 43 | 40 | 5.7 | 6.4 | 0.47 | 0.48 |
| 23 | 1043 | Cu | 30 | 26 | 5.7 | 6.0 | 0.56 | 0.58 |
| 24 | 1615 | Cu | 30 | 26 | 5.8 | 5.6 | 0.57 | 0.58 |
| 25 | 1615 | Cu | 39 | 35 | 5.9 | 6.2 | 0.49 | 0.49 |
| 26 | 1615 | Cu | 43 | 40 | 5.7 | 5.8 | 0.47 | 0.48 |
| 27 | 1043 | Cu | 30 | 26 | 5.7 | 6.0 | 0.56 | 0.57 |

TABLE 2

| | Example/ | | 1st | | | | 2nd | | |
|---|---|---|---|---|---|---|---|---|---|
| Sample | Comparative | 1st | dielectric | | d₁ | X1 | dielectric | | d₂ |
| No. | example | electrode | layer | ε₁ | (um) | (kJ/mol) | layer | ε₂ | (um) |
| 5 | Example | Ni | Ba(Mg_{1.73/3}Ta_{2.08/3})O₃ | 30 | 2 | 1914 | BaTiO₃ | 800 | 0.2 |
| 31 | Example | Ni | Ba(Mg_{1/3}Ta_{2/3})O₃ | 30 | 2 | 1615 | BaTiO₃ | 800 | 0.2 |
| 32 | Example | Ni | Ba(Mg_{1/3}Ta_{2/3})O₃ | 30 | 2 | 1615 | BaTiO₃ | 800 | 0.2 |
| 33 | Example | Cu | Ba(Mg_{1.73/3}Ta_{2.08/3})O₃ | 30 | 2 | 1914 | BaTiO₃ | 800 | 0.2 |
| 34 | Example | Ni | Ba(Mg_{1/3}Ta_{2/3})O₃ | 30 | 2 | 1615 | BaTiO₃ | 800 | 0.01 |
| 35 | Example | Ni | Ba(Mg_{1/3}Ta_{2/3})O₃ | 30 | 2 | 1615 | BaTiO₃ | 800 | 0.1 |
| 5 | Example | Ni | Ba(Mg_{1.73/3}Ta_{2.08/3})O₃ | 30 | 2 | 1914 | BaTiO₃ | 800 | 0.3 |
| 36 | Example | Ni | Ba(Mg_{1/3}Ta_{2/3})O₃ | 30 | 2 | 1615 | BaTiO₃ | 800 | 0.5 |
| 37 | Example | Ni | Ba(Mg_{1/3}Ta_{2/3})O₃ | 30 | 0.1 | 1615 | BaTiO₃ | 800 | 0.2 |
| 38 | Example | Ni | Ba(Mg_{1.73/3}Ta_{2.08/3})O₃ | 30 | 0.2 | 1615 | BaTiO₃ | 800 | 0.2 |
| 5 | Example | Ni | Ba(Mg_{1/3}Ta_{2/3})O₃ | 30 | 2 | 1914 | BaTiO₃ | 800 | 0.2 |
| 39 | Example | Ni | Ba(Mg_{1/3}Ta_{2/3})O₃ | 30 | 5 | 1615 | BaTiO₃ | 800 | 0.2 |

| | | | | | Adhesive | | Withstand | |
|---|---|---|---|---|---|---|---|---|
| | | | | | strength | | voltage | |
| | | | | | (no 2nd | | (no 2nd | |
| | | | | | dielectric | Adhesive | dielectric | Withstand |
| Sample | X2a | 2nd | | 0.8 × ε₁ × | layer) | strength | layer) | voltage |
| No. | (kJ/mol) | electrode | ε | ((d₁ + d₂)/d₁) | (N/mm²) | (N/mm²) | (kV/um) | (kV/um) |
| 5 | 890 | Cu | 40 | 26 | 5.7 | 11.9 | 0.57 | 0.59 |
| 31 | 890 | Cu | 40 | 26 | 5.8 | 12.2 | 0.56 | 0.57 |
| 32 | 890 | Cu | 40 | 26 | 5.7 | 12.1 | 0.56 | 0.57 |
| 33 | 890 | Cu | 40 | 26 | 5.6 | 11.9 | 0.57 | 0.58 |
| 34 | 890 | Cu | 30 | 24 | 5.7 | 12.3 | 0.56 | 0.56 |
| 35 | 890 | Cu | 35 | 25 | 5.7 | 12.1 | 0.56 | 0.56 |
| 5 | 890 | Cu | 46 | 28 | 5.7 | 11.9 | 0.57 | 0.57 |
| 36 | 890 | Cu | 58 | 30 | 5.7 | 12.4 | 0.56 | 0.57 |
| 37 | 890 | Cu | 268 | 72 | 5.8 | 12.3 | 0.56 | 0.56 |
| 38 | 890 | Cu | 155 | 48 | 5.6 | 12.2 | 0.56 | 0.56 |
| 5 | 890 | Cu | 40 | 26 | 5.7 | 11.9 | 0.57 | 0.59 |
| 39 | 890 | Cu | 34 | 25 | 5.8 | 12.1 | 0.56 | 0.60 |

According to Table 1 and Table 2, examples satisfying X2a<X1 and X2a≤1000 kJ/mol showed good adhesive strength and withstand voltage. On the other hand, when X2a was too large as in case of the comparative examples, the adhesive strength decreased. Also, when the proportion of Ti was 50 parts by mol or less to 100 parts by mol of the cationic ion element included in the B site of the perovskite type compound included in the first dielectric layer as in case of the examples, the adhesive strength significantly increased compared to the case which was carried out under the same condition except that the second dielectric layer was not formed. Further, when the proportion of Ti was 50 parts by mol or less to 100 parts by mol of the cationic ion element included in the B site of the perovskite type compound included in the first dielectric layer as in case of the examples, the withstand voltage increased.

### Experiment Example 2

Experiment example 2 had a different second dielectric layer compared to that of Experiment example 1. In below, a method of forming the second dielectric layer is described.

As raw material powders of the target, powders of silicon oxide (SiO₂), titanium oxide (TiO₂), zinc oxide (ZnO₂), aluminum oxide (Al₂O₃), iron oxide (Fe₂O₃), hafnium oxide (HfO₂), and tantalum oxide (Ta₂O₅) were prepared. The powders were weighed so that the composition of the second dielectric layer shown in Table 3 and Table 4 were satisfied.

The weighed raw material powders of the target was wet mixed for 20 hours in a ball mill using water as a solvent. The obtained mixed powder slurry was dried at 100° C., and thereby obtained the mixed powder. The obtained mixed powder was press molded using a pressing machine, and obtained a molded body. A molding condition was a pressure of 100 Pa, a temperature of 25° C., and a pressing time of 3 minutes.

Then, the obtained molded body was fired and a sintered body was obtained. As firing conditions, a holding temperature was within a range of 1300° C. to 1400° C., a holding time was within a range of 2 hours to 5 hours, and the atmosphere was in the air.

The obtained sintered body was processed into a size having a diameter of 200 mm and a thickness of 6 mm, using a surface grinding machine and a cylindrical grinding machine, thereby obtained a target for forming the second dielectric layer.

For other conditions, the Experiment example 2 was carried out under the same condition as in Experiment example 1. Results are shown in Table 3 and Table 4.

TABLE 3

| | Example/ | | 1st | | | | 2nd | | |
|---|---|---|---|---|---|---|---|---|---|
| Sample | Comparative | 1st | dielectric | | d₁ | X1 | dielectric | | d₂ |
| No. | example | electrode | layer | ε₁ | (um) | (kJ/mol) | layer | ε₂ | (um) |
| 41 | Example | Ni | CaZrO₃ | 30 | 2 | 1043 | SiO₂ | 3.8 | 0.04 |
| 42 | Example | Ni | CaTi_{0.2}Zr_{0.8}O₃ | 40 | 2 | 1012 | SiO₂ | 3.8 | 0.04 |
| 43 | Example | Ni | Ba(Mg_{1.73/3}Ta_{2.08/3})O₃ | 30 | 2 | 1914 | SiO₂ | 3.8 | 0.04 |
| 44 | Example | Ni | BaTi_{0.9}Zr_{0.1}O₃ | 800 | 2 | 905 | SiO₂ | 3.8 | 0.05 |
| 45 | Example | Ni | BaTi_{0.9}Zr_{0.1}O₃ | 400 | 2 | 920 | SiO₂ | 3.8 | 0.05 |
| 46 | Example | Ni | BaTi_{0.9}Zr_{0.1}O₃ | 800 | 2 | 905 | SiO₂ | 3.8 | 0.05 |
| 47 | Example | Ni | BaTi_{0.9}Zr_{0.1}O₃ | 400 | 2 | 920 | SiO₂ | 3.8 | 0.05 |
| 48 | Example | Ni | CaZrO₃ | 30 | 2 | 1043 | TiO₂ | 114 | 0.2 |
| 49 | Example | Ni | CaTi_{0.2}Zr_{0.8}O₃ | 40 | 2 | 1012 | TiO₂ | 114 | 0.2 |
| 50 | Example | Ni | Ba(Mg_{1.73/3}Ta_{2.08/3})O₃ | 30 | 2 | 1914 | TiO₂ | 114 | 0.2 |
| 51 | Example | Ni | CaZrO₃ | 30 | 2 | 1043 | ZnO | 8.5 | 0.1 |
| 52 | Example | Ni | CaTi_{0.2}Zr_{0.8}O₃ | 40 | 2 | 1012 | ZnO | 8.5 | 0.1 |
| 53 | Example | Ni | Ba(Mg_{1/3}Ta_{2/3})O₃ | 30 | 2 | 1615 | ZnO | 8.5 | 0.1 |
| 54 | Comparative | Ni | CaZrO₃ | 30 | 2 | 1043 | Al₂O₃ | 9.6 | 0.1 |
| | example | | | | | | | | |
| 55 | Comparative | Ni | CaTi_{0.2}Zr_{0.8}O₃ | 40 | 2 | 1012 | Al₂O₃ | 9.6 | 0.1 |
| | example | | | | | | | | |
| 56 | Comparative | Ni | Ba(Mg_{1.73/3}Ta_{2.08/3})O₃ | 30 | 2 | 1914 | Al₂O₃ | 9.6 | 0.1 |
| | example | | | | | | | | |
| 57 | Example | Ni | CaZrO₃ | 30 | 2 | 1043 | Fe₂O₃ | 1.6 | 0.02 |
| 58 | Example | Ni | CaTi_{0.2}Zr_{0.8}O₃ | 40 | 2 | 1012 | Fe₂O₃ | 1.6 | 0.02 |
| 59 | Example | Ni | Ba(Mg_{1/3}Ta_{2/3})O₃ | 30 | 2 | 1615 | Fe₂O₃ | 1.6 | 0.02 |
| 60 | Comparative | Ni | CaZrO₃ | 30 | 2 | 1043 | HfO₂ | 15 | 0.2 |
| | example | | | | | | | | |
| 61 | Comparative | Ni | CaTi_{0.2}Zr_{0.8}O₃ | 40 | 2 | 1012 | HfO₂ | 15 | 0.1 |
| | example | | | | | | | | |
| 62 | Comparative | Ni | Ba(Mg_{1/3}Ta_{2/3})O₃ | 30 | 2 | 1615 | HfO₂ | 15 | 0.2 |
| | example | | | | | | | | |
| 63 | Comparative | Ni | CaZrO₃ | 30 | 2 | 1043 | Ta₂O₅ | 27 | 0.2 |
| | example | | | | | | | | |
| 64 | Comparative | Ni | CaTi_{0.2}Zr_{0.8}O₃ | 40 | 2 | 1012 | Ta₂O₅ | 27 | 0.2 |
| | example | | | | | | | | |
| 65 | Comparative | Ni | Ba(Mg_{1/3}Ta_{2/3})O₃ | 30 | 2 | 1615 | Ta₂O₅ | 27 | 0.2 |
| | example | | | | | | | | |
| 66 | Comparative | Ni | CaZrO₃ | 30 | 2 | 1043 | Nb₂O₅ | 46 | 0.1 |
| | example | | | | | | | | |
| 67 | Comparative | Ni | CaTi_{0.2}Zr_{0.8}O₃ | 40 | 2 | 1012 | Nb₂O₅ | 46 | 0.1 |
| | example | | | | | | | | |
| 68 | Comparative | Ni | Ba(Mg_{1/3}Ta_{2/3})O₃ | 30 | 2 | 1615 | Nb₂O₅ | 46 | 0.1 |
| | example | | | | | | | | |
| 69 | Comparative | Ni | CaZrO₃ | 30 | 2 | 1043 | ZrO₂ | 35 | 0.1 |
| | example | | | | | | | | |
| 70 | Comparative | Ni | CaTi_{0.2}Zr_{0.8}O₃ | 40 | 2 | 1012 | ZrO₂ | 35 | 0.1 |
| | example | | | | | | | | |
| 71 | Comparative | Ni | Ba(Mg_{1.73/3}Ta_{2.08/3})O₃ | 30 | 2 | 1914 | ZrO₂ | 35 | 0.1 |
| | example | | | | | | | | |

| | | | | | Adhesive | | Withstand | |
|---|---|---|---|---|---|---|---|---|
| | | | | | strength | | voltage | |
| | | | | | (no 2nd | | (no 2nd | |
| | | | | | dielectric | Adhesive | dielectric | Withstand |
| Sample | X2a | 2nd | | 0.8 × ε₁ × | layer) | strength | layer) | voltage |
| No. | (kJ/mol) | electrode | ε | ((d₁ + d₂)/d₁) | (N/mm²) | (N/mm²) | (kV/um) | (kV/um) |
| 41 | 251 | Cu | 29 | 24 | 5.8 | 11.1 | 0.57 | 0.59 |
| 42 | 251 | Cu | 38 | 33 | 5.9 | 12.4 | 0.49 | 0.50 |
| 43 | 251 | Cu | 29 | 24 | 5.7 | 11.0 | 0.57 | 0.59 |
| 44 | 251 | Cu | 702 | 656 | 12.3 | 12.3 | 0.20 | 0.22 |
| 45 | 251 | Cu | 357 | 328 | 12.1 | 12.3 | 0.25 | 0.27 |
| 46 | 251 | Cu | 702 | 656 | 12.3 | 12.3 | 0.20 | 0.21 |
| 47 | 251 | Cu | 357 | 328 | 12.1 | 12.3 | 0.25 | 0.26 |
| 48 | 890 | Cu | 34 | 26 | 5.8 | 11.1 | 0.57 | 0.60 |
| 49 | 890 | CU | 44 | 35 | 5.9 | 10.8 | 0.49 | 0.49 |
| 50 | 890 | Cu | 34 | 26 | 5.7 | 10.4 | 0.57 | 0.55 |
| 51 | 318 | Cu | 28 | 25 | 5.8 | 11.5 | 0.57 | 0.60 |
| 52 | 318 | Cu | 37 | 34 | 5.9 | 11.0 | 0.49 | 0.50 |
| 53 | 318 | Cu | 28 | 25 | 5.7 | 10.8 | 0.57 | 0.60 |
| 54 | 1582 | Cu | 28 | 25 | 5.8 | 5.6 | 0.57 | 0.55 |
| 55 | 1582 | CU | 37 | 34 | 5.9 | 5.5 | 0.49 | 0.48 |
| 56 | 1582 | Cu | 28 | 25 | 5.7 | 5.8 | 0.57 | 0.56 |
| 57 | 742 | CU | 29 | 24 | 5.8 | 12.2 | 0.57 | 0.60 |
| 58 | 742 | Cu | 39 | 32 | 5.9 | 11.3 | 0.49 | 0.51 |
| 59 | 742 | CU | 29 | 24 | 5.7 | 11.5 | 0.57 | 0.58 |
| 60 | 1088 | Cu | 28 | 26 | 5.8 | 6.4 | 0.57 | 0.59 |
| 61 | 1088 | Cu | 38 | 34 | 5.9 | 5.7 | 0.49 | 0.49 |
| 62 | 1088 | Cu | 28 | 26 | 5.7 | 5.8 | 0.57 | 0.58 |
| 63 | 1911 | Cu | 30 | 26 | 5.8 | 5.9 | 0.57 | 0.56 |
| 64 | 1911 | Cu | 39 | 35 | 5.9 | 6.3 | 0.49 | 0.48 |
| 65 | 1911 | Cu | 30 | 26 | 5.7 | 6.2 | 0.57 | 0.60 |
| 66 | 1766 | Cu | 31 | 25 | 5.8 | 5.6 | 0.57 | 0.57 |
| 67 | 1766 | CU | 40 | 34 | 5.9 | 6.2 | 0.49 | 0.49 |
| 68 | 1766 | Cu | 31 | 25 | 5.7 | 6.3 | 0.57 | 0.57 |
| 69 | 1043 | CU | 30 | 25 | 5.8 | 6.0 | 0.57 | 0.60 |
| 70 | 1043 | Cu | 40 | 34 | 5.9 | 6.6 | 0.49 | 0.48 |
| 71 | 1043 | CU | 30 | 25 | 5.7 | 6.1 | 0.57 | 0.59 |

TABLE 4

| | Example/ | | 1st | | | | 2nd | | |
|---|---|---|---|---|---|---|---|---|---|
| Sample | Comparative | 1st | dielectric | | d₁ | X1 | dielectric | | d₂ |
| No. | example | electrode | layer | ε₁ | (um) | (kJ/mol) | layer | ε₂ | (um) |
| 50 | Example | Ni | Ba(Mg_{1.73/3}Ta_{2.08/3})O₃ | 30 | 2 | 1914 | TiO₂ | 114 | 0.2 |
| 81 | Example | Ni | Ba(Mg_{1/3}Ta_{2/3})O₃ | 30 | 2 | 1615 | TiO₂ | 114 | 0.2 |
| 82 | Example | Cu | Ba(Mg_{1/3}Ta_{2/3})O₃ | 30 | 2 | 1615 | TiO₂ | 114 | 0.2 |
| 83 | Example | Ni | Ba(Mg_{1.73/3}Ta_{2.08/3})O₃ | 30 | 2 | 1914 | TiO₂ | 114 | 0.01 |
| 84 | Example | Ni | Ba(Mg_{1.73/3}Ta_{2.08/3})O₃ | 30 | 2 | 1914 | TiO₂ | 114 | 0.1 |
| 50 | Example | Ni | Ba(Mg_{1.73/3}Ta_{2.08/3})O₃ | 30 | 2 | 1914 | TiO₂ | 114 | 0.2 |
| 85 | Example | Ni | Ba(Mg_{1.73/3}Ta_{2.08/3})O₃ | 30 | 2 | 1914 | TiO₂ | 114 | 0.5 |
| 86 | Example | Ni | Ba(Mg_{1/3}Ta_{2/3})O₃ | 30 | 0.5 | 1615 | TiO₂ | 114 | 0.2 |
| 87 | Example | Ni | Ba(Mg_{1/3}Ta_{2/3})O₃ | 30 | 1 | 1615 | TiO₂ | 114 | 0.2 |
| 50 | Example | Ni | Ba(Mg_{1.73/3}Ta_{2.08/3})O₃ | 30 | 2 | 1914 | TiO₂ | 114 | 0.2 |
| 88 | Example | Ni | Ba(Mg_{1.73/3}Ta_{2.08/3})O₃ | 30 | 5 | 1914 | TiO₂ | 114 | 0.2 |

| | | | | | Adhesive | | Withstand | |
|---|---|---|---|---|---|---|---|---|
| | | | | | strength | | voltage | |
| | | | | | (no 2nd | | (no 2nd | |
| | | | | | dielectric | Adhesive | dielectric | Withstand |
| Sample | X2a | 2nd | | 0.8 × ε₁ × | layer) | strength | layer) | voltage |
| No. | (kJ/mol) | electrode | ε | ((d₁ + d₂)/d₁) | (N/mm²) | (N/mm²) | (kV/um) | (kV/um) |
| 50 | 890 | Cu | 34 | 26 | 5.7 | 10.4 | 0.57 | 0.55 |
| 81 | 890 | Cu | 34 | 26 | 5.6 | 11.0 | 0.56 | 0.59 |
| 82 | 890 | Cu | 34 | 26 | 5.6 | 10.5 | 0.56 | 0.59 |
| 83 | 890 | Cu | 30 | 24 | 5.6 | 10.0 | 0.56 | 0.57 |
| 84 | 890 | Cu | 32 | 25 | 5.6 | 10.5 | 0.56 | 0.57 |
| 50 | 890 | Cu | 34 | 26 | 5.7 | 10.4 | 0.57 | 0.57 |
| 85 | 890 | Cu | 39 | 30 | 5.6 | 11.2 | 0.56 | 0.58 |
| 86 | 890 | Cu | 44 | 34 | 5.6 | 12.1 | 0.55 | 0.55 |
| 87 | 890 | Cu | 37 | 29 | 5.6 | 11.9 | 0.55 | 0.56 |
| 50 | 890 | Cu | 34 | 26 | 5.7 | 10.4 | 0.57 | 0.57 |
| 88 | 890 | Cu | 32 | 25 | 5.6 | 11.8 | 0.63 | 0.64 |

According to Table 3 and Table 4, examples satisfying X2b<X1 and X2b≤1000 kJ/mol showed good adhesive strength and withstand voltage. On the other hand, when X2b was too large as in case of the comparative examples, the adhesive strength decreased. Also, when the proportion of Ti was 50 parts by mol or less to 100 parts by mol of the cationic ion element included in the B site of the perovskite type compound included in the first dielectric layer as in case of the examples, the adhesive strength was significantly enhanced compared to the case which was carried out under the same condition except that the second dielectric layer was not formed. Further, when the proportion of Ti was 50 parts by mol or less to 100 parts by mol of the cationic ion element included in the B site of the perovskite type compound included in the first dielectric layer as in case of the examples, the withstand voltage increased.

For reference, an energy for formation of an oxide of each element used for calculating each of X1, X2a, and X2b of the above-examples is shown in Table 5.

TABLE 5
Energy for formation of an oxide (kJ/mol)

| | |
|---|---|
| Ti | −889.5 |
| Zr | −1042.82 |
| Mg | −1021.1 |
| Ta | −1911.3 |
| Si | −250.8 |
| Zn | −318.32 |
| Al | −1582.31 |
| Fe | −742.2 |
| Hf | −1088.2 |
| Nb | −1766.1 |

### Numerical References

100 . . . Thin film capacitor

10 . . . Substrate

20 . . . Insulation layer

30 . . . First electrode

40 . . . Dielectric layer

41 . . . First dielectric layer

42 . . . Second dielectric layer

50 . . . Second electrode

60 . . . Multilayer structure

70 . . . Protective film

What is claimed is:

1. A thin film capacitor having a multilayer structure comprising a first electrode, a first dielectric layer, a second dielectric layer, and a second electrode in this order; wherein
the second dielectric layer and the second electrode are in contact;
the first dielectric layer and the second dielectric layer comprise a perovskite type compound; and
X2a<X1 and X2a≤1000 kJ/mol are satisfied, in which
X1 represents an absolute value of an average energy for formation of an oxide of a cationic element included in a B site of the perovskite type compound included in the first dielectric layer, and
X2a represents an absolute value of an average energy for formation of an oxide of a cationic element included in a B site of the perovskite type compound included in the second dielectric layer.

2. The thin film capacitor according to claim 1, wherein
ε≥0.8×ε₁×((d₁+d₂)/d₁) is satisfied, in which
ε₁ represents a relative permittivity of the first dielectric layer,
d₁ represents a thickness of the first dielectric layer,
d₂ represents a thickness of the second dielectric layer,
ε₂ represents a relative permittivity of the second dielectric layer, and
ε represents a synthetic permittivity including ε₁ and ε₂.

3. The thin film capacitor according to claim 1, wherein a withstand voltage of the first dielectric layer is 0.30 kV/um or more.

4. A power source module comprising the thin film capacitor according to claim 1.

5. An electronic device comprising the power source module according to claim 4.

6. A thin film capacitor having a multilayer structure comprising a first electrode, a first dielectric layer, a second dielectric layer, and a second electrode in this order; wherein
the second dielectric layer and the second electrode are in contact;
the first dielectric layer comprises a perovskite type compound and the second dielectric layer comprises an oxide of M; and
X2b<X1 and X2b≤1000 kJ/mol are satisfied, in which
X1 represents an absolute value of an average energy for formation of an oxide of a cationic element included in a B site of the perovskite type compound included in the first dielectric layer, and
X2b represents an absolute value of an average energy for formation of an oxide of M included in the second dielectric layer.

7. The thin film capacitor according to claim 6, wherein
ε≥0.8×ε₁×((d₁+d₂)/d₁) is satisfied, in which
ε₁ represents a relative permittivity of the first dielectric layer,
d₁ represents a thickness of the first dielectric layer,
d₂ represents a thickness of the second dielectric layer,
ε₂ represents a relative permittivity of the second dielectric layer, and
ε represents a synthetic permittivity including ε₁ and ε₂.

8. The thin film capacitor according to claim 6, wherein a withstand voltage of the first dielectric layer is 0.30 kV/um or more.

9. A power source module comprising the thin film capacitor according to claim 6.

10. An electronic device comprising the power source module according to claim 9.
